(19) United States
(12) Patent Application Publication
(10) Pub. No.: US 2011/0282625 A1
(43) Pub. Date: Nov. 17, 2011

(54) Time Interval Analyzing System and a Method Thereof

(75) Inventors: Jan Craninckx, Boutersem (BE); Kameswaran Vengattaramane, Bangalore (IN); Jonathan Borremans, Lier (BE)

(73) Assignees: KATHOLIEKE UNIVERSITEIT LEUVEN, K.U. LEUVEN R&D, Leuven (BE); IMEC, Leuven (BE)

(21) Appl. No.: 13/105,454

(22) Filed: May 11, 2011

Related U.S. Application Data
(60) Provisional application No. 61/334,463, filed on May 13, 2010.

(51) Int. Cl. G04F 10/00; G06F 15/00

(52) U.S. Cl. 702/178

(57) ABSTRACT

A time interval measuring system is disclosed. In one embodiment, the time interval measuring system includes a plurality of time interval analyzers, each having a resolution that differs from a resolution of at least one other time interval analyzer in the plurality of time interval analyzers. The plurality of time interval analyzers are configured to receive a first event signal representing a first event, receive a second event signal representing a second event, and generate digital first estimates representing a time difference between the first event and the second event. The time interval measuring system further includes a post-processing unit configured to receive the digital first estimates and combine the digital first estimates according to at least one algorithm to generate a digital second estimate representing the time difference between the first event and the second event having higher precision than each of the digital first estimates.

### CROSS-REFERENCE TO RELATED APPLICATIONS

This application claims priority to U.S. Provisional Application 61/334,463 filed May 13, 2010, the contents of which are incorporated by reference herein in their entirety.

### BACKGROUND

The present disclosure relates to a time interval analyzing system arranged for measuring the time interval between two or more events.

Measurement of a time interval between two or more event instantiations arises in many scientific applications such as particle physics experiments, laser ranging, on-chip clock skew measurements. Instruments that perform this measurement and provide a quantized result are known as Time-to-Digital Converters (TDC). Recently due to technology scaling and the subsequent improvement in raw TDC resolutions, there has been a push towards using TDC as a replacement for the analog phase detector and charge pump typically used in phase locked loop (PLL) based frequency synthesizers. Several digitally-intensive PLL (DPLL) based frequency synthesizers have been recently demonstrated in complementary metal-oxide-semiconductor (CMOS) technology. However, the finite time resolution of the TDC introduces a quantization error in the phase information, which dominates the in-band phase noise performance as well as the spurious content of the synthesizer output. Thus high resolution is desired for better spectral purity. In addition, the measurement range of the TDC should preferably cover the full period of the reference crystal (˜10-30 ns) for settling and calibration of the TDC.

To address the resolution and the range requirements, a coarse-fine architectural approach is often seen in the state-of-the-art. The coarse TDC has a basic time resolution that is limited by technology and corresponds to the delay of a single inverter or buffer. Based on an inverter or buffer delay, a low complexity and wide range TDC can be constructed by enabling a ring oscillator made of a delay element, such as an inverter, to oscillate during the time to be measured and counting the number of state transitions of the delay elements. The fine TDC however relies on sophisticated analog circuit/system techniques to provide a delay resolution better than a single gate delay element. These techniques require a considerable effort from design point of view and are not compatible with a fully digital design flow.

### SUMMARY

In a first aspect, a time interval measuring system is disclosed for providing a digital output indicative of the time interval or time difference between a first event and a second event. The system includes a plurality of time interval analyzers, where each of the time interval analyzers has a different resolution. The plurality of time interval analyzers is arranged for receiving a common first event and a common second event and is further arranged for generating a plurality of digital first estimates indicative of the time difference between said first event and said second event. The system further includes a postprocessor unit configured to store and/or execute an algorithm, to receive the plurality of digital first estimates, and to combine the plurality of digital first estimates in accordance with the algorithm. In this manner, the system may generate a digital second estimate indicative of the time difference between said first event and said second event that is more highly precise than the plurality of digital first estimates. The postprocessor unit is further arranged for combining the plurality of first estimates into a second estimate of the time interval to be measured, thereby enhancing the measurement precision, or time resolution, of the time interval to be measured. In the context of this disclosure, time resolution may be understood to mean the smallest time interval or time difference between a first event and a second event that is measured by the time interval analyzers.

While analog-intensive components may be employed to improve the resolution of a delay element below a single gate delay, the disclosed system is more in keeping with the trend of digital CMOS signal processing in that no analog intensive components are used in this system, allowing a fully digital design approach. Time resolution enhancement beyond the basic gate delay is achieved through digital post-processing. Furthermore, the second estimate is robust to circuit imperfections and non-idealities like for example jitter or delay element mismatches.

Advantageously, the algorithm running in the post-processing unit can be configured to operate in different modes which can be executed either in sequence (i.e., one after another) or in parallel (i.e., one or more at the same time). The different modes include but are not limited to (a) quantizing the plurality of received coarse first timing estimates with a floor function and calculating the maximum, thereby generating the digital second estimate, (b) quantizing the plurality of received coarse first timing estimates with a round function and calculating the average, thereby generating the digital second estimate, and (c) quantizing the plurality of received coarse first timing estimates with a floor function and calculating the maximum, quantizing the plurality of received coarse first timing estimates with a ceiling function and calculating the minimum, and calculating the average of the maximum and the minimum, thereby generating the digital second estimate.

Each of the plurality of time interval analyzers may further comprise a first input port arranged for receiving the first event signal, a second input port arranged for receiving the second event signal, and an output port for outputting the digital first estimate. Further, each of the plurality of time interval analyzers may comprise a combinatorial logic circuit configured for receiving the first event and the second event and generating a pulsed signal with a rising edge representative of the first event signal and a falling edge representative of the second event signal. Further, each of the plurality of time interval analyzers may comprise a plurality of delay stages connected in a cascade configuration arranged for receiving the pulsed signal, where each delay stage can be configured for outputting a delayed version of said pulsed signal, thereby providing a plurality of quantization grids for estimating the time difference between the first event and the second event. Further, each of the plurality of time interval analyzers may further comprise a plurality of sampling circuits for sampling and comparing the pulsed signal against the plurality of quantization grids and for generating a plurality of decisions. Each of the plurality of time interval analyzers may further include means for combining the decisions into the digital first estimate.

In one embodiment the means for combining the plurality of decisions may comprise an adder. In an alternative embodiment the means for combining the plurality of decisions may comprise a thermometer to digital decoder, and the plurality of decisions from the sampling circuits may be combined to generate the digital first estimate from each time interval analyzer.

The improved operation of the time interval analyzers utilized in the disclosed time interval measurement system is highly dependent on the generation of a uniform quantization grid for sampling the time interval or time difference between the first event and second event at constantly increasing intervals. Each delay stage comprises at least one delay element for providing the quantization step or time resolution by which the time difference between the first event and second event is estimated. Each delay stage out of the plurality of delay stages has an identical number of delay elements with fixed time delay, thereby ensuring the uniformity of the quantization grid.

The delay elements in each time interval analyzer are part of a digital standard cell library, thereby allowing a fully digital design flow.

In some embodiments, each time interval analyzer has a different resolution, causing the time delay of the delay stages in each time interval analyzer is different. In other embodiments, the plurality of delay stages can be arranged in a ring oscillator configuration for generating a plurality of clock signals, where the ring oscillator is activated by the rising edge of the pulsed signal and deactivated by the falling edge of the pulsed signal.

Each of the plurality of sampling circuits utilized for sampling and comparing the pulsed signal against the plurality of quantization grids or the plurality of the clock signals may further comprise one or more digital binary counters for counting the number of times the pulsed signal or each of the generated clock signals appeared between the arrival time of the first event and the arrival time of the second event.

A method for measuring the time difference between a first event and a second event is also disclosed. In one embodiment, the method may include receiving a first event and a second event and inputting the first event and second event into a plurality of time interval analyzers, where each of the said time interval analyzers has a different time resolution. The method may further include measuring the time difference between the first event and the second event in each of the plurality of time interval analyzers and generating a plurality of digital first estimates from the plurality of time interval analyzers. Further, the method may include multiplying each digital first estimate with the resolution of the respective time interval analyzer in the post-processing unit, combining the plurality of multiplied first estimates in the post-processing unit, and generating from the plurality of multiplied first estimates a digital second estimate indicative of the time difference between said first event and second event. The second estimate may be of higher resolution than the first digital estimate.

In some embodiments, combining the plurality of multiplied first estimates in the post-processing unit may involve calculating the maximum of the plurality of received coarse first timing estimates, thereby generating the digital second estimate. In other embodiments, combining the plurality of multiplied first estimates in the post-processing unit may involve calculating the average of the plurality of received coarse first timing estimates, thereby generating the digital second estimate. In still other embodiments, combining the plurality of multiplied first estimates in the post-processing unit may involve quantizing the plurality of received coarse first timing estimates with a floor function and calculating the maximum, quantizing the plurality of received coarse first timing estimates with a ceiling function and calculating the minimum, and calculating the average of the maximum and the minimum, thereby generating the digital second estimate.

In some embodiments, measuring the time difference between the first event and the second event in each of the plurality of time interval analyzers may involve combining the first event and the second event into a pulsed signal with a rising edge representative of the first event signal and a falling edge representative of the second event signal, generating a plurality of quantization grids, sampling and comparing the pulsed signal against the plurality of quantization grids to generate a plurality of decisions, and combining the plurality of decisions into a digital first estimate. The plurality of decisions may be combined by, for example, summing.

### BRIEF DESCRIPTION OF THE DRAWINGS

Various embodiments are described below in conjunction with the appended drawing figures, wherein like reference numerals refer to like elements in the various figures.

FIG. 1 shows a time interval measuring system, in accordance with an embodiment.

FIG. 2 illustrates a method for measuring a time interval, in accordance with an embodiment.

FIG. 3 illustrates an example principle of combining quantization grids with different resolutions into a single grid with a higher resolution, in accordance with an embodiment.

FIGS. 4a-h shows example quantization error profiles for various processing algorithms, in accordance with an embodiment.

FIGS. 5a-b illustrates example resolution enhancement obtained through various processing algorithms, in accordance with an embodiment.

FIG. 6 shows a plot illustrating an example inter-element delay mismatch impact, in accordance with an embodiment.

FIG. 7 shows a plot illustrating an example impact of varying offsets in different time-interval analyzers, in accordance with an embodiment.

FIG. 8 shows a plot illustrating an example jitter impact, in accordance with an embodiment.

FIG. 9 shows an implementation including a ring oscillator, in accordance with an embodiment.

FIG. 10 illustrates example measured transfer functions of channels, in accordance with an embodiment.

FIG. 11 illustrates an example impact of multi-channel activation on the non-linearity of the first channel, in accordance with an embodiment.

FIGS. 12a-d illustrate example impacts of differential non-linearity spread on a synthesized quantization error, in accordance with an embodiment.

FIG. 13 shows an example plot illustrating a relationship between a measured resolution and a number of channels, in accordance with an embodiment.

### DETAILED DESCRIPTION

The present disclosure will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present invention, the only relevant components of the device are A and B.

Systems and methods are disclosed for enhancing the resolution of a time interval measurement system below a single gate delay by using explicitly digital design techniques. In the disclosed systems and methods, no transistor-level modification is required. Further, the disclosed systems and methods are fully compatible with a digital design flow implementation.

The system of the present disclosure is related to a simultaneous multi-channel measurement of a time interval using low complexity time interval analyzers of varying resolutions. The digital outputs generated by the converter are digitally post-processed to obtain an output whose precision is much better than that of the individual converters.

Typically, fully custom circuit techniques are most commonly utilized for enhancing the resolution of a time interval analyzer below a single gate delay. This means that the circuit elements used to provide the quantization grid are modified at the transistor level requiring a fully custom circuit approach. These techniques frequently involve transistors operating in the ‘analog’ region, which result in large area overheads, higher power consumption, and complex mode of operation. As a result, these type of circuits cannot benefit from the scaling of CMOS technology and thus their use is not suited for certain applications, such as fully DPLL applications, which ideally require circuit elements like transistors to operate in ‘digital’ region to exploit the benefits of digital system design like faster simulation and testing, easier process migration, and robustness against variability in characteristics of circuit elements like transistors.

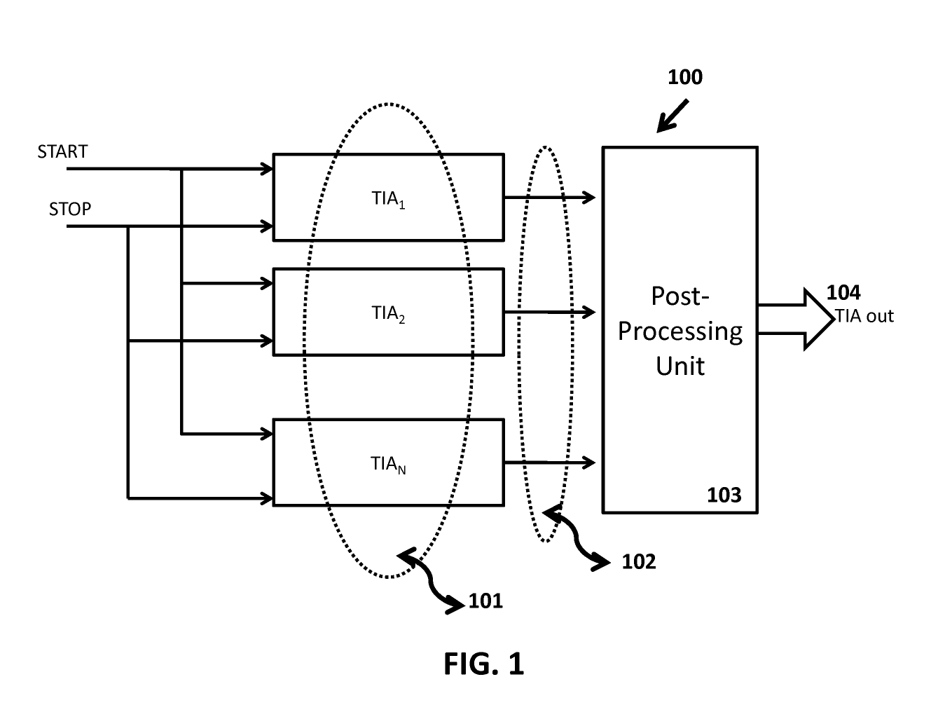

FIG. 1 shows a time interval measuring system 100, in accordance with an embodiment. The time interval measuring system 100 may be configured to measure a time interval between a first event (“START”) and a second event (“STOP”) and generate a digital output 104 indicative of the time difference between the arrival time of the first event and the arrival time of the second. To this end, the time interval measuring system 100 may include a plurality of time interval analyzers 101 connected in parallel with each other and a postprocessor unit configured to store and/or execute an algorithm 103. Each time interval analyzer 101 may be configured to receive the first event and the second event. Further, each time interval analyzer 101 may be configured to generate a digital first estimate 102 of the time interval between the first event and the second event, as registered by the time interval analyzer.

In some embodiments, to enhance the resolution of the time interval measuring system 100 at least two of the time interval analyzers 101 may have differing resolution with respect to one another. In other embodiments, to further enhance the resolution of the time interval measuring system 100, each of the time interval analyzers 101 may have resolution that differs from all of the other time interval analyzers 101. For example, each time interval analyzer 101 may have a fixed resolution Tᵢ.

The post-processing unit 103 may be configured to receive from the time interval analyzers 101 the digital first estimates 102. The post-processing unit 103 may include at least one processor and data storage. The data storage may be integrated in whole or in part with the at least one processor. The data storage may include at least one algorithm executable by the processor to combine the digital first estimates 102 received from the time interval analyzers 101 into a digital second estimate 104 that represents the time interval elapsed between the first event and the second event.

In this manner, the time interval measuring system 100 may simultaneously measure a time interval using each of a plurality of low-complexity time interval analyzers 101 having differing resolutions. The time interval analyzers 101 may produce a plurality of digital first estimate 102 that may be combined algorithmically to produce a second digital estimate 104 having better resolution than each of the digital first estimates 102.

Each time interval analyzer 101 may include combinatorial logic circuit configured to combine the first event and second event into a pulsed signal with a rising edge representing the first event and a falling edge representing the second event. Each time interval analyzer 101 may further include a plurality of delay stages arranged in a cascade configuration. Each delay stage may comprise at least one delay element and may be configured to receive the pulsed signal generated by the combinatorial logic circuit.

The delay stages can be arranged in different configurations for generating a quantization grid for estimating the time interval between the arrival time of the first event and the arrival time of the second event. The delay stages may be used to generate the differing resolutions of the time interval analyzer 101, such as the fixed resolutions fixed resolution Tᵢ described above.

Example delay stage configurations include, but are not limited to, a ring oscillator configuration, a simple delay chain, and/or any linear progression of delay elements. Other configurations are possible as well. The delay elements may be configured to provide a number of delayed versions of the pulsed signal, each of which represents a quantization grid with which the time interval to be measured can be approximated or estimated.

In some embodiments, each of the delay elements may be enabled following the first event. Further, each of the delay elements may trigger simple binary counters of each phase configured to count at least until the second event. The total count registered by each counter rack multiplied by the nominal delay Tᵢ of the corresponding ring oscillator may provide a coarse quantized estimate, namely a digital first estimate 102, of the time interval between the first event and the second event. The digital first estimate 102 may have a resolution Tᵢ.

The digital first estimates 102 generated by each of the time interval analyzers 101 may be received by the post-processing unit 103. The post-processing unit 103 may combine the digital first estimates 102 to generate a grid having finer grid steps than the quantization grids generates in the time interval analyzers 101. In this manner, the post-processing unit 103 may emulate a fine interpolation without using analog voltages.

In some embodiments, the number of delay stages and delay elements contained within each time interval analyzer 101 may be the same. In order to achieve a differing time resolution in a given time interval analyzer 101, the time delay of each delay stage in the time interval analyzer 101 may be modified (e.g., increased) using, for example, a passive circuit, such a capacitor circuit to modify (e.g., increase) the input load of each delay stage, which will consequently increase the time delay of the delay stage. In other embodiments, the number of delay elements comprised in each delay stage of the time interval analyzers 101 may vary. In order to achieve a differing time resolution in a given time analyzer 101, a larger number of delay elements could be used (e.g., the cascade of each delay stage could increase in linear steps with the different delay elements).

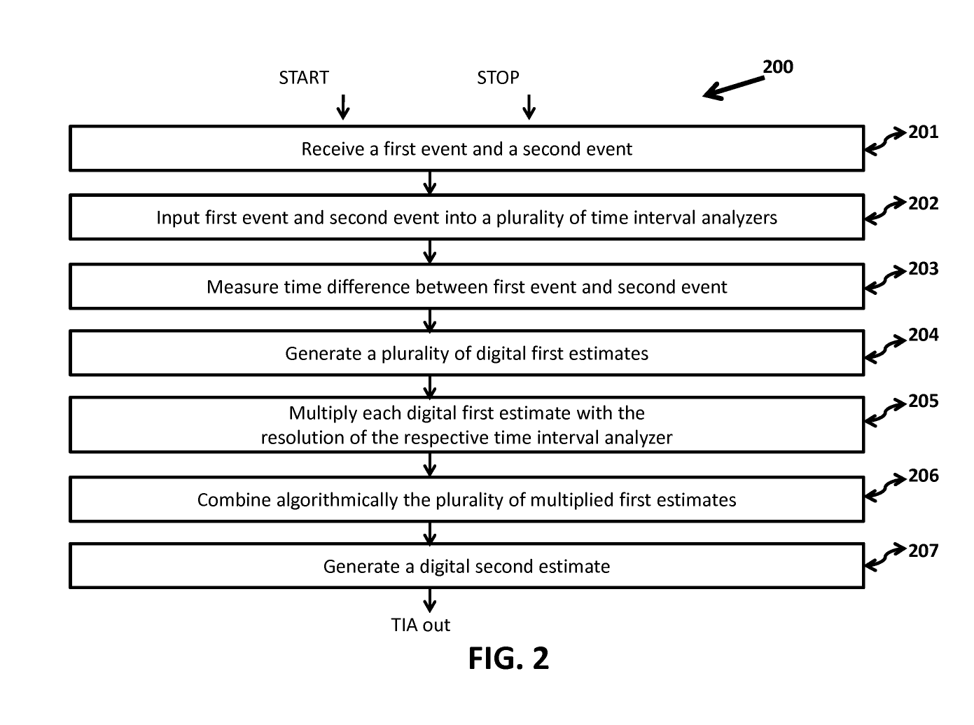

FIG. 2 illustrates a method 200 for measuring a time interval, in accordance with an embodiment. As shown, the method 200 begins at block 201 where a first event and a second event are received. The method 200 continues at block 202 where the first event and the second event are input into a plurality of time interval analyzers, such as the time interval analyzers 101 described above in connection with FIG. 1. The method 200 continues at block 203 where a time difference between the first event and the second event is measured by each of the time interval analyzers. At block 204, each of the time interval analyzers generates a digital first estimate based on its measured time difference between the first event and the second event. The method 200 continues at block 205 where each digital first estimate is multiplied by a resolution of the time interval analyzer that produced the digital first estimate. At block 206, the multiplied first digital estimates are combined by a post-processing unit, such as the post-processing unit 103 described above in connection with FIG. 1. At block 208, the post-processing unit combines the multiplied digital first estimates algorithmically to generate a second digital estimate of the time interval between the first event and the second event. The second digital estimate may have a greater resolution than any of the digital first estimates.

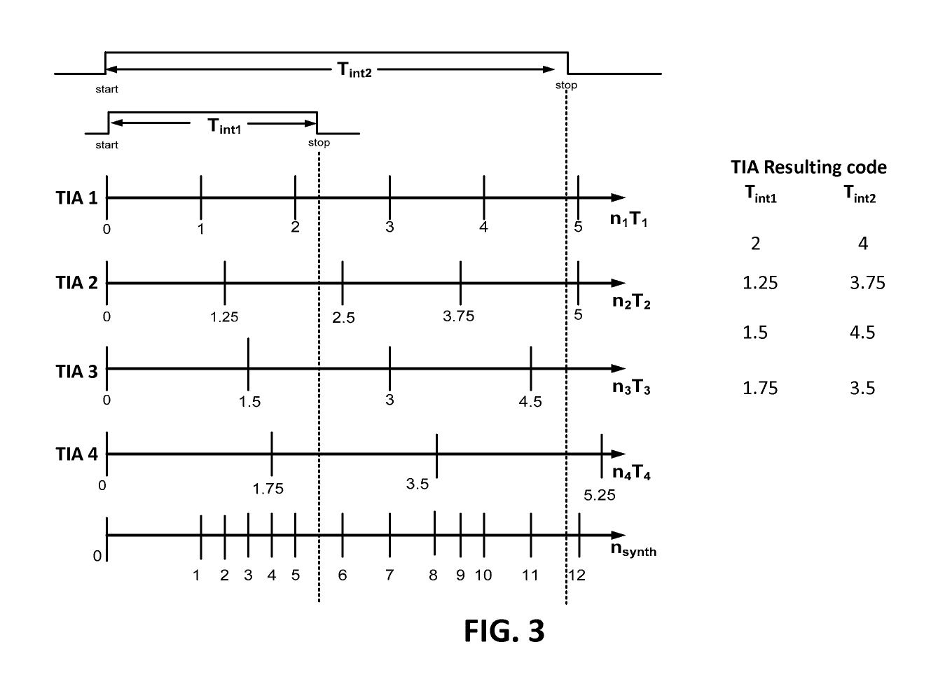

FIG. 3 illustrates an example principle of combining quantization grids with different resolutions into a single grid with a higher resolution, in accordance with an embodiment. As shown, a four-channel time interval measuring system includes four time interval analyzers with respective arbitrary resolutions T₁-T₄. The variable of interest is the time along the x-axis. This is subject to the quantization grids of the individual time interval analyzers, which may be given by n₁T₁-n₄T₄. Consider a time interval measured from ‘0’ to ‘Tᵢₙₜ₁’, 2.2 T_{d} where T_{d} is the delay of a minimum sized delay element in any technology for example. The resulting code readouts (the digital first estimates) from individual time interval analyzers are [2, 1, 1 and 1] respectively. After multiplying with the corresponding time interval analyzer resolutions, these are [2 1.25 1.5 1.75] T_{d}. As observed, the reading with the least quantization error is 2 T₁=2 T_{d} from the first time interval analyzer, TIA 1. Consider another interval measured from ‘0’ to ‘Tᵢₙₜ₂’, 3.6T_{d}. With this interval, it is seen that the best approximation is 3 T₃=3.5 T_{d} obtained from the fourth time interval analyzer, TIA 4. Intuitively, since the quantization used is akin to a mathematical ‘floor’ function, the maximum of all the quantized values would be the best approximate. There are 12 distinct levels in the post-processed grid (n_{synth}) for the given input time range with ‘max’ operation, as compared to an average 3.5 time intervals in grids of T₁-T₄. It is to be noted that these sub-intervals are spaced non-uniformly due to the unrelated edges of the time interval analyzers. In an ideal case, if all four time interval analyzers (TIA 1, TIA 2, TIA 3, and TIA 4) had the same resolution T but varied only by a phase of /4, there would have been 16 edges, on an equidistant grid. However, it is hard to achieve such fine phase spacing in practical CMOS technology implementations, and this would be subject to the locking of the delay lines in the four time interval analyzers with identical frequency. Nevertheless, even though the edges are present on a non-uniform grid, when a small time window (such as the one in present example) is chosen, a factor of 3.4× (though 4× is possible in an ideal case) improvement in the number of distinct edges is obtained. This emulates an interpolation, but without making use of any analog node voltages. As the time window is moved, the number of edges also varies. Further, adding more channels (time interval analyzers) with slightly offset resolutions may improve the effective number of sub-intervals created within a time window of interest, thereby further increasing the resolution of the digital second estimate.

Resolution can thus be improved without the effort required in analog time interval analyzers. It can be seen that no complex circuit techniques are needed, as the resolution enhancement is derived from time interval analyzers having differing resolutions creating unrelated but non-overlapping edges that can be post-processed using simple algorithms, such as a ‘max’ operation. Unlike a conventional converter, which samples a time input and provides a binary code output, the post-processing scheme disclosed herein provides a quantized time output that is product ‘nT’. Further, unlike conventional time interval measurement systems in which parallel channels are used to quantize different time inputs simultaneously, in this scheme all parallel channels measure the same interval. For the disclosed system the resolution improvement is obtained essentially by simple digital post-processing on digital first estimates generated by several, parallel, low resolution and low complexity time interval analyzers. These time interval analyzers and the post-processing unit can be designed using a fully digital design flow, which may include the use of high level description languages such as, for example, VHDL or Verilog. One advantage of this approach is that, since it relies on purely digital techniques, the best benefits of digital flow can be exploited in a radio frequency (RF) PLL system like ease of design and layout, faster system validation and seamless process migration without performance penalties. Importantly, the resolution improvement obtained is robust against process variations.

The algorithm used by the post-processing unit may take several forms. In one example, the algorithm may be a ‘max’ algorithm that selects the maximum of all quantized time out values. An example ‘max’ algorithm is shown as equation (1).

max [symbol] nᵢTᵢ [symbol] (1)

In another example, the algorithm may be a ‘max-min’ algorithm that takes an average of the maximum of all the quantized time outs quantized with a ‘floor’ function and the minimum of all the quantized time outs quantized with a ‘ceil’ function. The ‘max-min’ algorithm may provide a better estimate (and thus further resolution enhancement) than the simple ‘max’ algorithm. An example ‘max-min’ algorithm is shown as equation (2).

mean [symbol] max [symbol] nᵢTᵢ [symbol] ,min [symbol] (nᵢ+1)Tᵢ [symbol] [symbol] (2)

In yet another example, the algorithm may be a ‘mean’ algorithm that determines a mean of the individual code outputs nᵢ scaled by the corresponding resolutions T. The ‘mean’ algorithm may be more robust to converter non-idealities such as mismatch between the channels as well as jitter. An example ‘mean’ algorithm is shown as equation (3).

mean [symbol] (nᵢ+0.5)Tᵢ [symbol] (3)

To quantify the resolution enhancement of different algorithms, the root mean square (rms) of the quantization error for a given input time range is used. In an ideal quantization, with a step size of ‘T_{Q}’, the variance of the quantization error assuming a uniformly spread error can be found in literature. An example variance is shown as equation (4).

$${σ}^{2} = \frac{{T}_{Q}^{2}}{12} \qquad ( 4 )$$

For the systems of the present disclosure, the quantization error does not have a uniform distribution as a result of the unequal quantization sub-grid. Accordingly, the quantization noise distribution is best characterized with the help of a histogram of the quantization error for a given time input range.

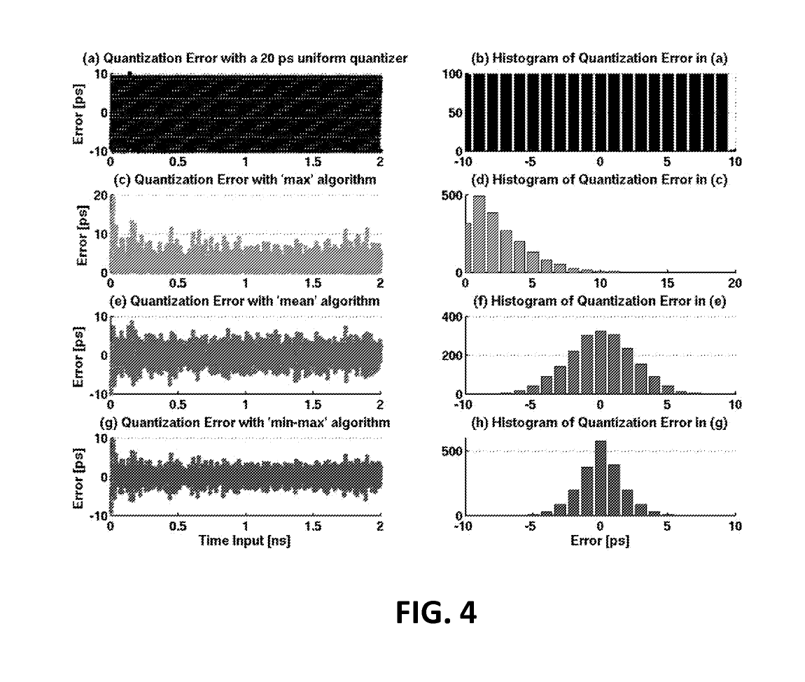

As an example, consider an input time-interval ramp [0 to 2] ns applied to a time interval measuring system that includes with 8 parallel time interval analyzers having resolutions spread [20 to 27] ps. FIG. 4 shows example quantization error profiles for various processing algorithms, in accordance with an embodiment.

As shown in FIG. 4a, an ideal quantizer of 20 ps step size has a quantization error having a saw tooth profile. The quantization error shown in FIG. 4(a) is spread uniformly between [−10 10] ps, as shown in FIG. 4b, with a standard deviation of the error being 5.8 ps, as obtained using equation (4).

FIGS. 4c-4h show quantization error profiles and spreads for each of the ‘max’, ‘mean’ and ‘max-min’ algorithms described above. The root mean square (rms) of post processed output is reduced in all the three algorithms (2.29 ps, 2.4 ps and 1.72 ps) compared to the 20 ps uniform quantizer. A reduced rms indicates that the input is quantized on a finer grid. It can clearly be seen from the histograms in this behavioral simulation that, in the case of parallel time interval analyzers, the central bins are populated more than in the uniform quantization case. This means that the quantization error for the majority of inputs is smaller. Also, it is seen that, initially for inputs in the range [0 to 100] ps, the quantization error has a larger spread due to the spacing of the individual time interval analyzer edges. This may be seen as start-up effects. In applications like DPLL, it can be ensured that in the steady state the time interval analyzer input range avoids this range. For larger inputs (e.g., inputs greater than 100 ps), the channel edge spacing is more uncorrelated and thus better emulates a higher resolution quantizer for these inputs. The density of edges for a relative interval also changes with absolute input range. A 500 ps interval in the range [1 to 1.5] ns will have different number of edges compared to the interval [2 to 2.5] ns. Based on the reduced quantization error rms a ‘synthesized’ quantizer resolution can then derived. An example synthesized quantizer resolution is shown as equation (5).

Q_{synth}=\sqrt{12}σ (5)

A resolution enhancement factor, given by the ratio of average quantization rms of individual channels to the synthesized quantizer resolution Q_{synth}) can then be used for characterizing the algorithms.

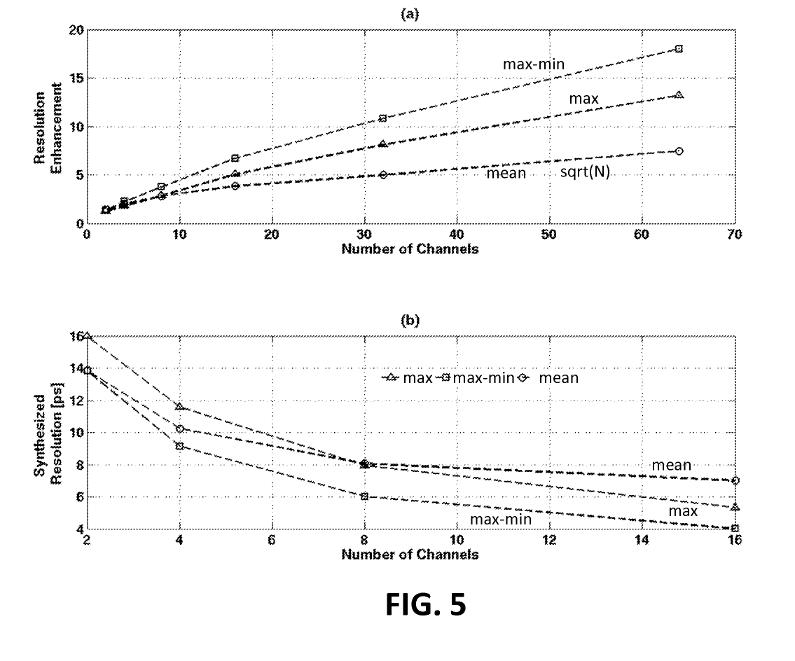

FIGS. 5a-b illustrates example resolution enhancement obtained through various processing algorithms, in accordance with an embodiment. In particular, FIG. 5a shows the resolution enhancement obtained from the three algorithms described above (max, max-min, and mean) as a function of number of channels in an N channel system, with a channel separation of 1 ps (Tᵢ₊₁=Tᵢ+1 ps, T₁=21 ps). The input is a time ramp [0 to 5] ns. As shown, 1 ps separation is taken in an average sense, fixed during construction, and no additional elements are needed during the operation to maintain this difference.

As shown, the ‘mean’ algorithm provides an \sqrt{N} enhancement (traced by black dashed-line), which can be expected due to the averaging operation. With the ‘max’ algorithm, an improvement of better than \sqrt{N} is observed. The ‘min-max’ algorithm follows a trend (traced by black dashed-line) which is \sqrt{2} better than the ‘max’. This is intuitively explained since the ‘max-min’ is an arithmetic average of ‘max’ and ‘min’

FIG. 5b shows the synthesized resolution of each algorithm as a function of the number of channels. The ‘max-min’ algorithm provides the best resolution compared to the other algorithms. It is seen that increasing the number of channels does provide better resolution. Beyond eight channels however, the synthesized quantizer improves only modestly as N progressively increases.

A similar trend in resolution enhancement is also observed with coarser quantizers and nominal 1 ps spacing. A moderate 10 to 20% improvement in synthesized resolution can be obtained by spacing channels very close (e.g., less than 1 ps). Although closely spaced channels bring some improvement, it also means that, within a given time interval, there are more edges. For example with an eight channel pack spread 0.2 ps starting with 35 ps has ˜450 edges in a 2 ns interval. With 2 ps spacing there are only 382 edges.

It is worth noting that the lower the number of edges is, the lower the power expended in that interval is, since lower current would be consumed by the delay elements. The 20% improvement in resolution is thus offset by reduced energy efficiency. Besides, such precise control of channels is complicated, and increases the risk of pulling.

It is further worth noting that this technique with better than \sqrt{N} improvement involves no complex analog circuit design techniques and as CMOS minimum feature size down-scaling favors the digital operation of transistors, cost of a simple inverter based coarse time interval analyzer is quite low. Since the standard resolution (gate delay) of an inverter scales with the technology, this method has the potential to provide, for example, less than 10 ps resolution with an easier digital design flow. Resolution gain is obtained as a consequence of relative offset in the channel coarse resolutions. An important merit of this scheme is that the resolution enhancement obtained is robust against process variations.

In practical single channel implementations of the disclosed time interval measuring system, issues such as mismatch and jitter may affect the performance of the converter and hence the overall effective resolution achievable. Mismatch in the individual delay elements of the individual channels creates code length deviations from a nominal value of ‘Tᵢ’. The expanded/contracted codes result in wider quantization noise variance. The standard deviation of the quantization error for a given input range [0 to T_{DR}] with the corresponding code out ‘n’ and the mean code length of ‘Tᵢ’ provides an estimated of the total noise added.

$${σ}_{NL} = \sqrt{{\int }_{0}^{{T}_{DR}} \frac{{( {T}_{x} - {nT}_{i} )}^{2}}{{T}_{DR}} d {T}_{x}} \qquad ( 6 )$$

This includes the noise expected assumes a uniform step-size of ‘Tᵢ’ (4), and an additional contribution from non-uniform step size. This additional contribution indeed depends on the non-linearity profile. The parallel time interval analyzer functionality is still valid in a multichannel time measuring system where all the individual channels are subject to differential non-linearity (DNL) and integral non-linearity (INL) variations, but the effective noise variance would be somewhat degraded due to the additional non-linearity induced errors from the individual time interval analyzer channels.

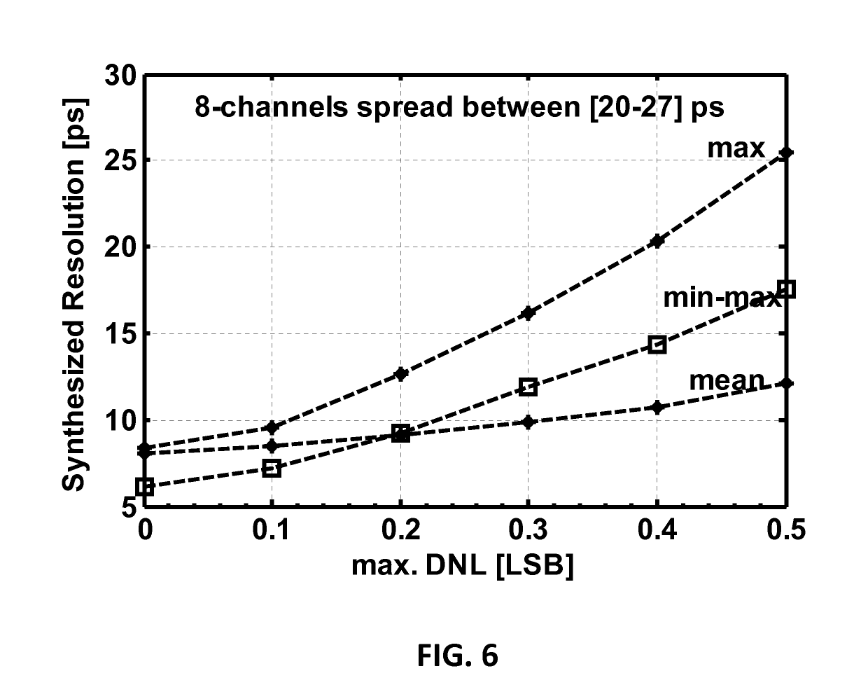

In behavioral simulations incorporating a mismatch effect, a representative 11-stage coarse 8 channel time interval analyzer with coarse resolutions [20 to 27] ps was used with increasing DNL added to the channel thresholds. FIG. 6 shows a plot illustrating an example inter-element delay mismatch impact, in accordance with an embodiment.

In particular, FIG. 6 shows the synthesized resolution when subject to an input ramp [0.2 to 5] ns for each of the algorithms discussed above. Although the max and mean algorithm provide similar synthesized resolutions in the ideal case (max. DNL=0 LSB), it is seen that with the introduction of mismatch, the synthesized resolution of the max algorithm deteriorates by 17 ps (max. DNL 0.5 least significant bit (LSB)). The mean algorithm, on the other hand, is quite robust with variation of a modest 2 ps. This ‘max’ algorithm is particularly sensitive to mismatch since it selects only one channel output. The max-min algorithm is better by a factor \sqrt{2} than max algorithm with a degradation of only 10 ps. With ‘max-min’ case, there is improvement because it averages the ‘max’ and ‘min’ channels. It can be intuitively reasoned that with the mean algorithm, the quantization errors from individual channels are averaged and since these errors are uncorrelated to a large extent, the sum of the errors do not differ much from an ideal case. It is thus noted that although the mean algorithm intrinsically provides less synthesized resolution than ‘max-min’ algorithm, it is relatively robust against mismatch effect. The mismatch effect in this case is generally related to the mismatch of the delay of the delay elements due to variations in the process technology. Since the ‘max’ and ‘max-min’ algorithms rely on the closest edge principle and non-linearity affects the edge placement, these algorithms are susceptible to mismatch compared to the ‘mean’ algorithm.

A second issue is mismatch of offset between channels. In a standard time interval measuring system, offset is typically not a problem (e.g. in a PLL). In the disclosed time interval measuring system, although the channels measure the same input Tᵢₙₚ, mismatch on their offset exists. The offset mismatch is different from the gate delay mismatch discussed in the previous paragraph in the sense that the offset mismatch remains a constant for each individual channel. This difference in the channel offsets results in performance degradation as the inputs to different channels are no longer the same. The performance of the three algorithms is studied with the presence of different offsets in the individual channels. The offset mismatch model assumes an offset mismatch which should ideally be identical for all the channels and to this a certain random offset with Gaussian statistics of zero is added. In the simulations, a mean offset of 200 ps (which is reasonable in practice) is chosen.

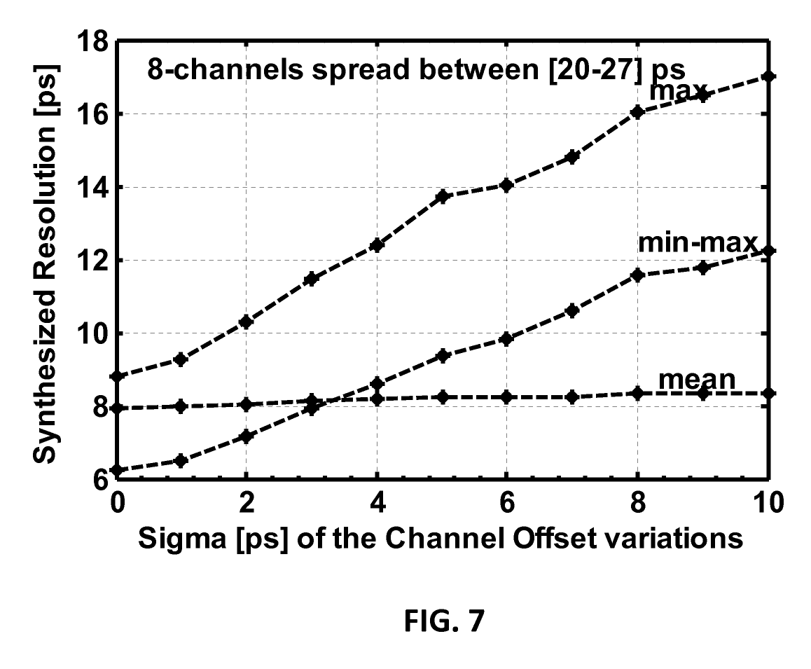

FIG. 7 shows a plot illustrating an example impact of varying offsets in different time-interval analyzers, in accordance with an embodiment. In particular, FIG. 7 shows the result of a simulation where a time ramp [0.2 to 5] ns is taken as the input to an 8-channel time interval measuring system with a base resolution of 21 ps and the channels spread 1 ps. The sensitivity of the various algorithms (max, max-min and mean) to the variation in the individual channel offsets in an 8-Channel time interval measuring system is shown. The mean algorithm has the least sensitivity and thus is robust against this non-ideality, whereas the ‘max’ algorithm performs very poorly. This is due to the fact that in ‘max’ algorithm the closest edge is used as the best approximation and a 1-LSB error due to offset directly impacts the output without being averaged as in mean algorithm.

Another issue is the presence of jitter in the individual channels. The dominant random jitter mechanism in delay element based time interval measuring system is accumulative. This causes the jitter to increase with the input time interval being measured, as the edges become progressively corrupted (noisy) when propagating through a series of delay elements. This can be modeled as an additive random jitter process with zero mean and a standard deviation proportional to \sqrt{M} (where ‘M’ is └T/T_{Q}┘) which adds to the time interval time interval being measured. This manifests as quantization error rms when repeatedly measuring the same interval, which may also be referred as single-shot precision rms.

The impact of jitter on the post-processing algorithms has been asserted through behavioral simulation. FIG. 7 shows a plot illustrating an example impact of varying offsets in different time-interval analyzers, in accordance with an embodiment.

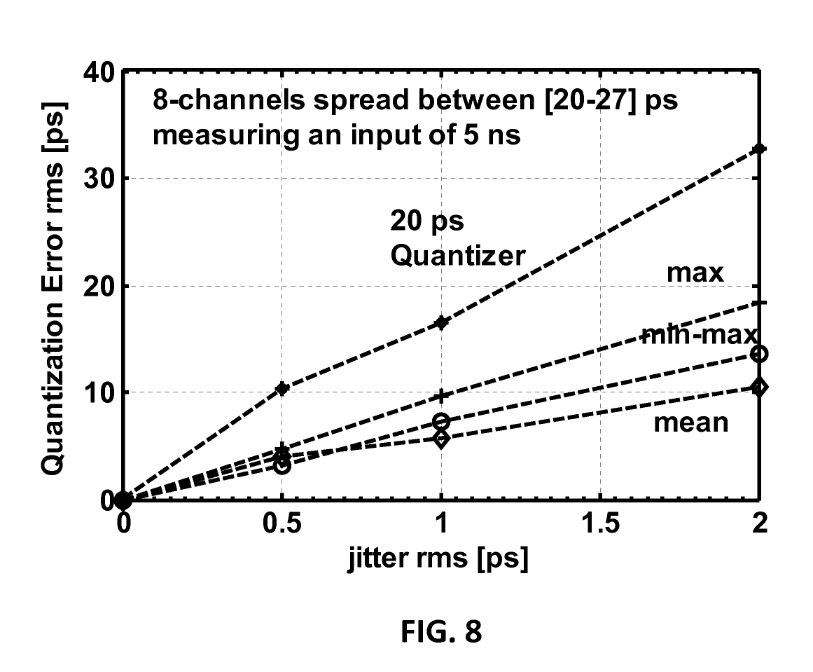

FIG. 8 shows a plot illustrating an example jitter impact, in accordance with an embodiment. In particular, FIG. 8 shows the jitter performance of the algorithms in an 8-channel system measuring a 5 ns interval with a rms jitter per stage varied [0 to 2] ps. Also shown is the case of a single quantizer of 20 ps measuring the same interval and subject to the same input jitter. There is significant improvement in jitter performance of parallel time interval measuring system compared with a single quantizer. This can be intuitively explained as in a parallel time interval measuring system, a new output is produced when a new edge occurs on any channel. Since jitter among channels is uncorrelated, the accumulative jitter mechanism is subdued. Compared to ‘max’ algorithm, ‘min-max’ is better by ˜\sqrt{2} since it is an average of ‘max’ and ‘min’ The best jitter performance is obtained with ‘mean’ algorithm, as in addition to the subdued accumulative jitter, there is also jitter averaging due to the ‘mean’ nature. It is seen that compared to a single quantizer, the error rms with ‘mean’ algorithm is ˜\sqrt{8} better.

From the system level behavioral simulations incorporating mismatch, offset, and jitter, it can be concluded that the synthesized output from the mean algorithm has better precision than do the max and max-min for larger system non-idealities. For smaller non-idealities, though, the max-min algorithm provides a better precision. These post-processing algorithms can be selected based on actual system characteristics in practice, since all three can be stored in and/or executable by the post-processing unit. This switching feature guarantees optimum performance in face of non-idealities and thus the system performance is robust.

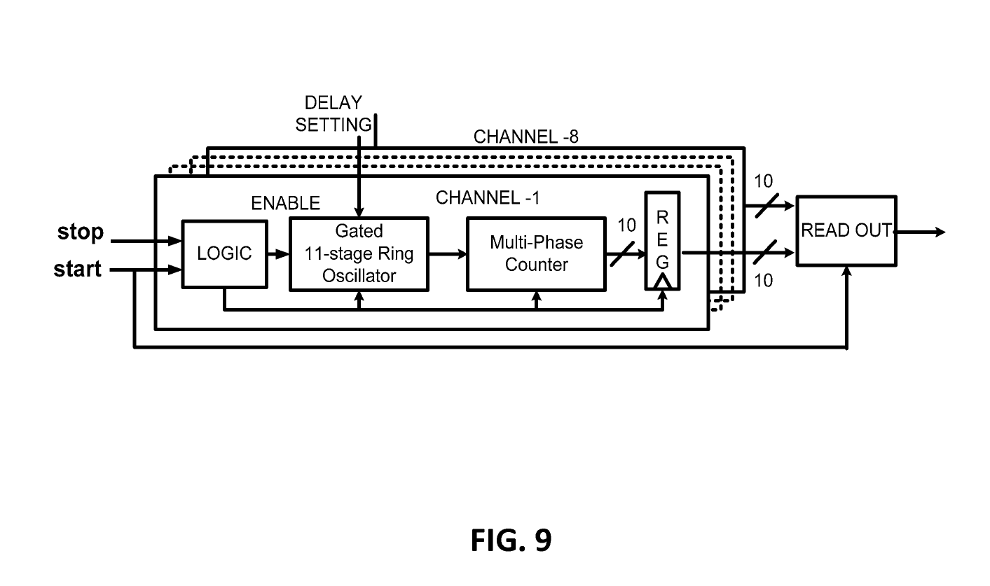

FIG. 9 shows an implementation including a ring oscillator, in accordance with an embodiment. A parallel time measuring system with 8 channels is implemented in 90 nm CMOS. The ring oscillators comprise programmable delay elements for adjusting the delay of each stage. This implementation allows a wider experimentation scope to verify whether the channels lock when their delays are closely spaced. The counters, read-out, and control circuitry are all standard cell based. The read-out circuitry takes 8 clock cycles to transmit the code out data from the individual channels. All the channels may, for example, include a ring oscillator with delay programmability driving a rack of counters. The system is triggered by two clocks—namely, start and stop—which are combined to generate an ‘enable’ signal to permit oscillations during the time interval of interest.

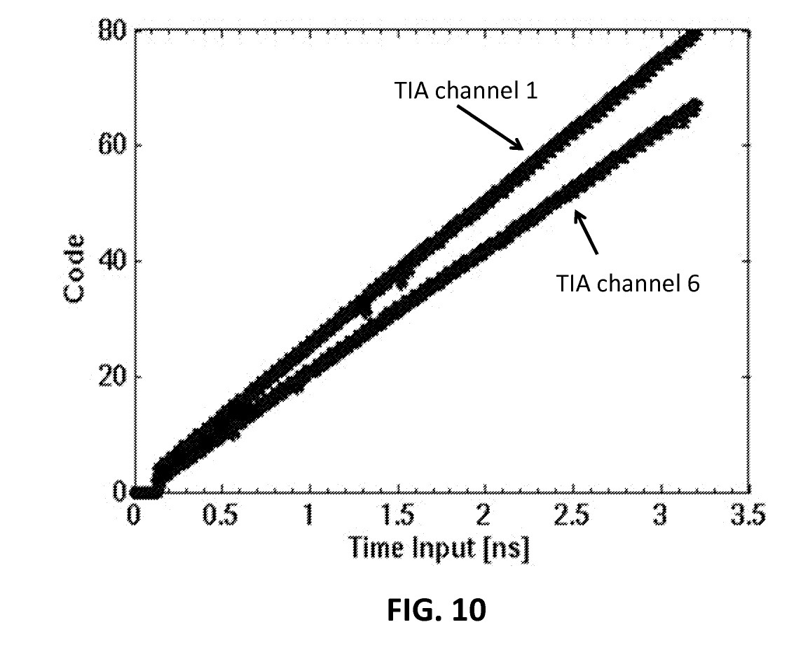

FIG. 10 illustrates example measured transfer functions of channels, in accordance with an embodiment. It can be seen from FIG. 10 that the ring oscillators of channels do not lock to a single oscillation frequency in a simultaneous multichannel mode, as shown in the measured different code versus time input slopes. The ring oscillator locking ensures the correct system functionality. FIG. 10 shows a plot of the measured code versus the time transfer function for 2 of the 8 active channels. The measured buffer (two inverters) delay is given by the code out versus time, which is also called transfer function. The measured resolutions of channels 1-8 are shown in Table 1.

TABLE 1

| | Channel Number | | | | | | | |
|---|---|---|---|---|---|---|---|---|
| | 1 | 2 | 3 | 4 | 5 | 6 | 7 | 8 |
| Measured | 51.9 | 53.7 | 54.9 | 56.2 | 57.3 | 58.7 | 61.9 | 63.4 |
| Resolution [ps] | | | | | | | | |

As explained in the previous section on non-ideality, mismatch in the individual channels increases the rms of synthesized quantization. The individual channel INL/DNL is obtained by a histogram analysis of code outputs subject to an input time ramp. For this measurement, the channel delays are spread [52-62] ps. An important aspect of this design is the influence of the simultaneous operation of the time interval analyzers on one another—specifically the profile of the INL and DNL curves in a simultaneous multichannel mode, as this influences the effective resolution obtained.

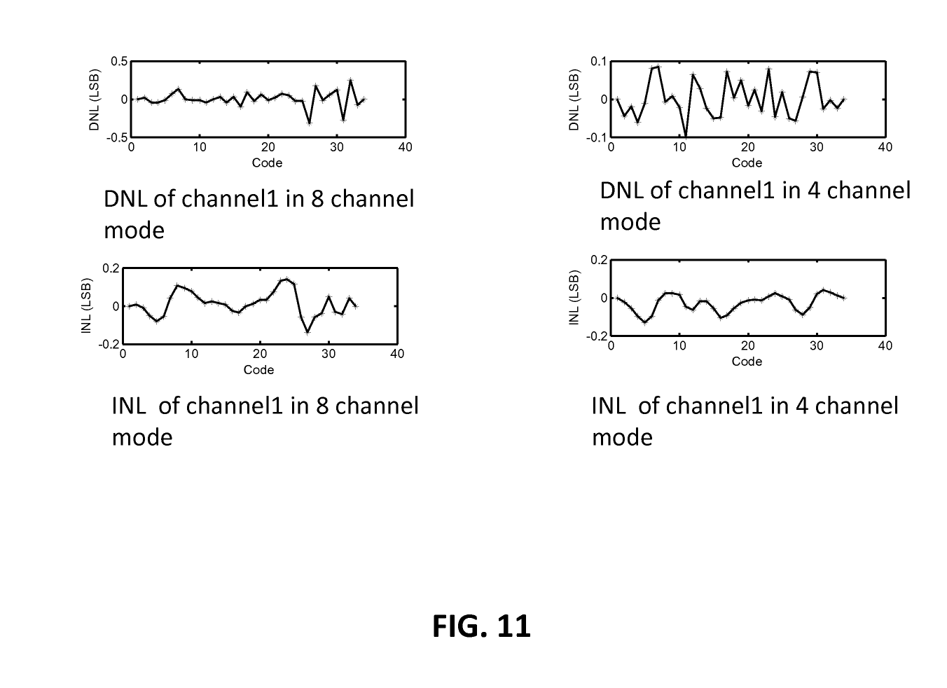

FIG. 11 illustrates an example impact of multi-channel activation on the non-linearity of the first channel, in accordance with an embodiment. In particular, FIG. 11 shows the DNL of a first channel (channel 1) in a stand alone mode and in 4/6/8 channel modes. As shown, the DNL of the first channel increases slightly with number of channels, and the INL largely stays within 10 ps in the operating region of interest.

The individual ring-oscillator-based time interval analyzers have a time in-code out characteristic. But, the post-processing system has a code in-quantized time out characteristic. Therefore INL/DNL for the multi-channel system is not strictly defined in the conventional sense. However, the extra deviation in the individual channel codes due to DNL would add to the overall quantization error since the code thresholds would have expanded/contracted.

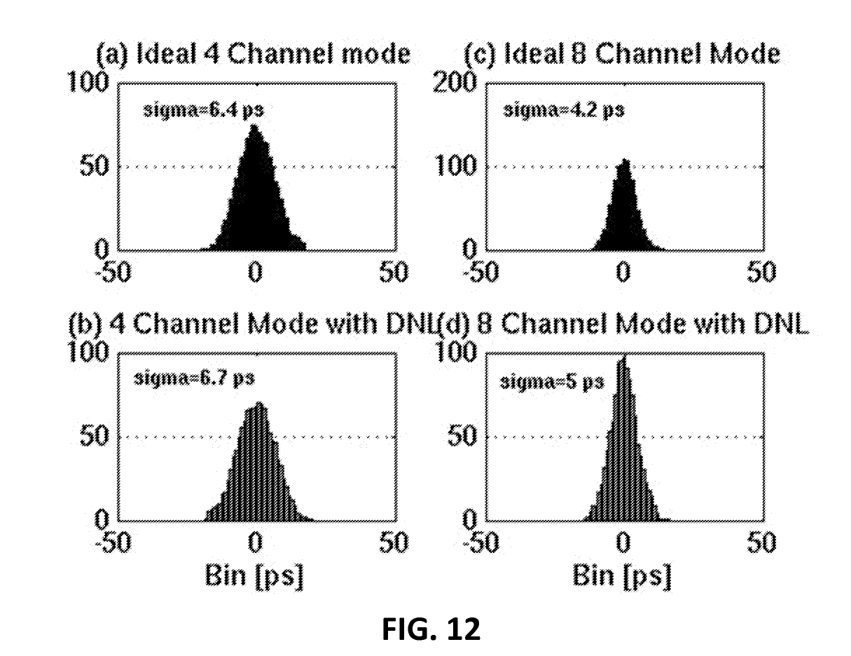

A reliable method to characterize the noise impact is to incorporate threshold deviations in each channel and compute the variance of quantization error for an input ramp. FIGS. 12a-d illustrate example impacts of DNL spread on a synthesized quantization error, in accordance with an embodiment.

FIG. 12(a) depicts an ideal 4 channel mode with the resolution set (no DNL). The quantization noise has a sigma of 6.4 ps in the ideal case using the mean algorithm. FIG. 12(b) depicts a 4 channel mode with DNL. Due to impact of measured DNL spread in 4 channel mode, the resulting sigma is 6.7 ps with the mean algorithm, and the impact is not that significant. For an 8 channel case shown (ideal case is shown in FIG. 12(c), with DNL in FIG. 12(d)), the measured sigma due DNL variations is 5 ps compared to 4.2 ps in ideal case using the mean algorithm. Thus, in case of the 8 channel mode, an improvement of 3× has been achieved compared with the individual ring oscillator TDC with buffer delay of 52 ps (which would have a sigma of 15 ps).

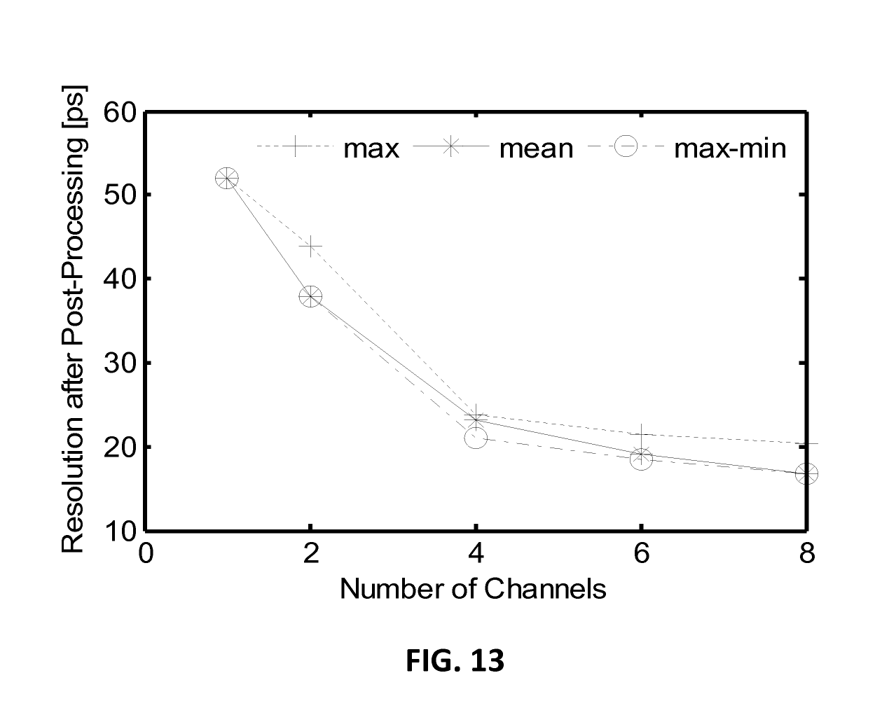

FIG. 13 shows an example plot illustrating a relationship between a measured resolution and a number of channels, in accordance with an embodiment. In particular, FIG. 13 shows the impact of NL on the synthesized resolution as a function of number of channels with the three algorithms. As shown, the mean algorithm provides the best resolution in 8 channel case whereas the max-min provides the best resolution in the 4 channel case. The post processing algorithm with the resolution set [52-62] ps in an 8 channel mode with the mean algorithm is expected to give 15 ps over a buffer delay of 52 ps. Including the DNL deviations this slightly degrades to 17 ps.

What is claimed is:

1. A time interval measuring system, comprising:
a plurality of time interval analyzers each having a resolution that differs from a resolution of at least one other time interval analyzer in the plurality of time interval analyzers, wherein the plurality of time interval analyzers are configured to:
receive a first event signal representing a first event,
receive a second event signal representing a second event, and
generate respective digital first estimates representing a time difference between the first event and the second event; and
a post-processing unit configured to:
receive the respective digital first estimates, and
combine the respective digital first estimates according to at least one algorithm to generate a digital second estimate representing the time difference between the first event and the second event having higher precision than each of the respective digital first estimates.

2. The time interval measuring system of claim 1, wherein combining the respective digital first estimates according to the at least one algorithm to generate the digital second estimate comprises:
quantizing the respective digital first estimates using a floor function; and
calculating the maximum of the quantized respective digital first estimates, thereby generating the digital second estimate.

3. The time interval measuring system of claim 1, wherein combining the respective digital first estimates according to the at least one algorithm to generate the digital second estimate comprises:
quantizing the respective digital first estimates using a round function; and
calculating the average of the quantized respective digital first estimates, thereby generating the digital second estimate.

4. The time interval measuring system of claim 1, wherein combining the respective digital first estimates according to the at least one algorithm to generate the digital second estimate comprises:
quantizing the respective digital first estimates using a floor function;
calculating the maximum of the respective digital first estimates quantized using the floor function;
quantizing the respective digital first estimates using a ceiling function;
calculating the minimum of the respective digital first estimates quantized using the ceil function; and
calculating the average of the maximum and the minimum, thereby generating the digital second estimate.

5. The time interval measuring system of claim 1, wherein the time interval analyzers are further configured to receive the first event signal and the second event signal in a multichannel configuration.

6. The time interval measuring system of claim 1, wherein each time interval analyzer comprises:
a first input port configured to receive the first event signal;
a second input port configured to receive the second event signal; and
an output port configured to output the respective digital first estimate.

7. The time interval measuring system of claim 6, wherein each time interval analyzer further comprises:
a combinatorial logic circuit configured to receive the first event signal and the second event signal and generate a pulsed signal, wherein the pulsed signal comprises a rising edge representing the first event signal and a falling edge representing the second event signal;
a plurality of cascaded delay stages configured to receive the pulsed signal and output a respective delayed version of the pulse signal, thereby generating a plurality of quantization grids;
a plurality of sampling circuits configured to compare the pulsed signal with respective quantization grids in the plurality of quantization grids and, based on the comparison, generate a plurality of respective decisions; and
a combining unit configured to combine the plurality of respective decisions to generate the respective digital first estimate.

8. The time interval measuring system of claim 7, wherein the combining unit comprises an adder.

9. The time interval measuring system of claim 7, wherein the combining unit comprises a thermometer-to-digital decoder.

10. The time interval measuring system of claim 7, wherein each delay stage in the plurality of cascaded delay stages comprises at least one delay element.

11. The time interval measuring system of claim 7, wherein the plurality of cascaded delay stages produces a time delay that differs from a time delay produced in each other time interval analyzer in the plurality of time interval analyzers.

12. The time interval measuring system of claim 7, wherein:
the plurality of cascaded delay stages comprise a ring oscillator configured to generate a plurality of respective clock signals; and
the ring oscillator is configured to be activated by the rising edge and deactivated by the falling edge.

13. The time interval measuring system of claim 7, wherein each sampling circuit comprises a digital binary counter.

14. A method, comprising:
providing a plurality of time interval analyzers, wherein each time interval analyzer has a respective resolution that differs from a respective resolutions of at least one other time interval analyzer in the plurality of time interval analyzers;
receiving at the plurality of time interval analyzers a first event signal representing a first event;
receiving at the plurality of time interval analyzers a second event representing a second event;
using the time interval analyzers using to measure a time difference between the first event and the second event and, based on the time difference, generate a plurality of respective digital first estimates representing the time difference between the first event and the second event;
for each time interval analyzer, multiplying the respective digital first estimate generated by the time interval analyzer by the respective resolution of the time interval analyzer to produce a respective multiplied digital first estimate;
combining the respective multiplied digital first estimates according to at least one algorithm to generate a digital second estimate representing the time difference between the first event and the second event having higher precision than each of the respective digital first estimates.

15. The method of claim 14, wherein combining the respective digital first estimates according to the at least one algorithm to generate the digital second estimate comprises:
quantizing the respective digital first estimates using a floor function; and
calculating the maximum of the quantized respective digital first estimates, thereby generating the digital second estimate.

16. The method of claim 14, wherein combining the respective digital first estimates according to the at least one algorithm to generate the digital second estimate comprises:
quantizing the respective digital first estimates using a round function; and
calculating the average of the quantized respective digital first estimates, thereby generating the digital second estimate.

17. The method of claim 14, wherein combining the respective digital first estimates according to the at least one algorithm to generate the digital second estimate comprises:
quantizing the respective digital first estimates using a floor function;
calculating the maximum of the respective digital first estimates quantized using the floor function;
quantizing the respective digital first estimates using a ceiling function;
calculating the minimum of the respective digital first estimates quantized using the ceil function; and
calculating the average of the maximum and the minimum, thereby generating the digital second estimate.

18. The method of claim 14, wherein, for each time interval analyzer, measuring the time difference between the first event and the second event comprises:
combining the first event signal and the second event signal to generate a pulsed signal, wherein the pulsed signal comprises a rising edge representing the first event signal and a falling edge representing the second event signal;
generating a plurality of quantization grids;
comparing the pulsed signal with respective quantization grids in the plurality of quantization grids;
based on the comparison, generating a plurality of respective decisions; and
combining the plurality of respective decisions to generate a respective digital first estimate.

19. The method of claim 18, wherein combining the plurality of respective decisions comprises summing the plurality of respective decisions.

20. The method of claim 14, wherein each time interval analyzer having a respective resolution that differs from a respective resolutions of at least one other time interval analyzer in the plurality of time interval analyzers comprises each time interval analyzer having a respective resolution that differs from a respective resolution of each other time interval analyzer in the plurality of time interval analyzers.
